(19) United States
(12) Patent Application Publication
(10) Pub. No.: US 2005/0289520 A1
(43) Pub. Date: Dec. 29, 2005

(54) Unidirectional cloaking device for source code

(75) Inventor: David Redvers Overall, London (GB)

Correspondence Address: BROWN & MICHAELS, PC;400 M & T BANK BUILDING, 118 NORTH TIOGA ST, ITHACA, NY, 14850, US

(73) Assignee: Redvers Consulting, Ltd., London (GB)

(21) Appl. No.: 10/880,250

(22) Filed: Jun. 29, 2004

(51) Int. Cl. G06F 9/44

(52) U.S. Cl. 717/137

(57) ABSTRACT

A system and method for transforming a source code into a more manageable form. The method includes the steps of: reading the input source code; identifying a set of data names and a set of label names having a predetermined word length; comparing the set of data names and the set of label names with a predetermined list; and assigning a cloaked name and placing the same within a predetermined list and to replace the identified data name with the cloaked name. Also, to remove non-essential punctuation, space and new-line characters.

### BACKGROUND OF THE INVENTION

1. Field of the Invention

The invention pertains to the field of computing. More particularly, the invention pertains to an apparatus and a set of method for protecting the contents contained in a source code by removing some text and positional structure therein without changing the program logic.

2. Description of Related Art

Many computer programming languages in use today are self documenting. This self documentation is achieved by the fact that programmers need to use informative data names (names given to variables held in computer storage), informative label names (names given to points in the logic where processing can jump to) and comments (comments do not affect the program logic, they are used to provide information only) in order to understand and maintain the programs they write. Also, statements within the source code can be grouped together to form phrases or sentences, punctuated with semicolons, commas or periods (full stops). In addition, the use of a separate line for each statement and the indentation of statements on these lines are used to convey the logical relationships that exist between statements. All this means that the innermost workings of a computer program can be understood by any individual who cares to read the souce code, even if they are not trained in the programming language in question.

Currently, compilers are used to reduce source code to machine language objects and these are then sent to backup sites or marketed to customers. The problem with this is that the backup or customer computer must use exactly the same operating system and often the same version of that operating system, in order to run the object code. Also, no helpful information can be gained from reading object code, therefore no details on the type and format of files being read/written can be obtained and absolutely no comments are discernible. Therefore, it is desirous to use a type of “preserve mode” to provide file details and other selected comments that are particularly useful to offsite users and software producers who wish to allow customers the facility to customize their source code.

By way of an example, some COBOL compilers have an option to produce assembler code when they compile a COBOL program and there are also some known products in the market that can produce assembler listings from COBOL source code input. Assembler code does convey input/output file details to an experienced assembler programmer but it does not include any of the useful comments that can be retained by the use of “preserve mode” as described infra in the present invention. Also, assembler languages are specific to each computer operating system and therefore can't be run on alternative operating systems or platforms.

An additional problem with using machine language objects or assembler code for outsourced development or backup, relates to the use of source code added at compile time as a result of compiler directing statements like COPY or INCLUDE. COPY/INCLUDE code is held as members in shared libraries so that all programs within a system have access to a standard set of commonly used record layouts or logical procedures. This means that if a COPY/INCLUDE member is changed, all the programs that use the member have to be recompiled. This recompilation requirement frequently occurs in the development of computer systems and can be done easily if all the code remains in source code form. However machine language objects or assembler code cannot use COPY/INCLUDE library members and will therefore need to be changed manually.

Some companies running bespoke applications, particularly if they are considering outsourcing to external companies, running offsite backup or if they are planning to archive a system, generally run the risk of exposing their source code to potentially undesirous parties. Further, source codes in their respective original form, typically take up more space in that its storage space usually can be compacted in one form or another. In addition, producers of software tools may encounter similar problems.

It is known in the art to transform entities such as a source code by means of encryption/decryption, encoder/decoder, scrambler, compressor/decompression, “shield”, “mask” and “hashing”, etc.

U.S. Pat. No. 4,418,275 entitled DATA HASHING METHOD AND APPARATUS teaches the hashing of a key data signal is accomplished by utilizing a pseudo random number signal generator for generating a randomized signal in response to the key data signals and an output register for serially receiving the generated pseudo-random signal and for providing segments of the serially-received signal at its output. A counting circuit responsive to a preselected number of shift signals provides an output valid signal when the preselected number of shift signals has occurred and further shifts the pseudo-random number signal-generator an amount corresponding to the preselected number of shift signals. The method of the present invention utilizes the steps of presetting the pseudo-random number generator and the counting circuit to an initialized state. The counting circuit is then loaded with a predetermined count whereupon key data is entered into the pseudo-random number generator so as to randomize the key data. A valid signal is provided when a block of key data has been hashed and the steps of entering the key data and providing a valid signal upon the occurrence of each block of key data is repeated until all key data blocks have been hashed. However, the pseudo random number therein does NOT seem to include an identifier therein such as letter “0” for distinction purposes.

U.S. Pat. No. 6,021,275 entitled OBJECT CODE STRUCTURE AND METHOD FOR TRANSLATION OF ARCHITECTURE INDEPENDENT PROGRAM IMPLEMENTATIONS teaches endian-independent representation of literal data, pointer data, literal operands and pointer operands. For literal data represented in a data section, an associated data translation script provides an Intercode translator with translation instructions for transforming byte ordering within the data section on a unit-of-storage by unit-of-storage basis (if required for the particular target processor). In this way, literal data of arbitrary structure can be specified independent of endian format. For pointer data represented in the data section, the associated data translation script provides the Intercode translator with relocation expressions for transforming pointer data values to effective memory addresses. Relocation expressions compute a linear combination of relterms, wherein relterms include constants, data section addresses, function gate addresses, and translation time constants. The translation time constants evaluate to a first value if evaluated on a little-endian target processor and to a second value if evaluated on a big-endian target processor. In this way, pointer data values can be specified independent of actual runtime location of the data to which the pointer operand refers and independent of endian format. A sequence of transformation instructions and relocation expressions are provided in the form of a data translation script to allow for endian-independent representation arbitrary data structures which include both literal and pointer data. As can be seen, this patent is not related to source code translation.

U.S. Pat. No. 6,408,433 entitled METHOD AND APPARATUS FOR BUILDING CALLING CONVENTION PROLOG AND EPILOG CODE USING A REGISTER ALLOCATOR teaches a method and apparatus for building calling convention prolog and epilog code using a register allocator teaches Methods and apparatus for enabling a register allocator to build a calling convention. According to one aspect of the present invention, a computer-implemented method for generating code associated with a calling convention includes obtaining compilable source code, and identifying at least one argument associated with the calling convention. The location of the argument with respect to memory space is described by a register mask. The method also includes performing a register allocation using a register allocator that is arranged to allocate registers. During the register allocation, code associated with the calling convention is produced automatically by the spill-code mechanism in the allocator without requiring the use of a specialized prolog or epilog code generator. As can be seen, the '433 patent is, in one aspect, directed toward masking the register for improved subroutine calling.

U.S. Pat. No. 5,925,126 entitled METHOD FOR SECURITY SHIELD IMPLEMENTATION IN COMPUTER SYSTEM'S SOFTWARE teaches a security shield implementation method comprising computer software for use with a computer system's software which is transparent to the user of the computer system software and utilizes the steps of system call interception and interactive command interception to control access by a user of the computer system software. The system call interception for non-interactive commands, file access, programs, networks, and the interactive commands, such as access to interactive programs, are routed and examined by redirector software. Security rule checks and log event functions are then conducted on the non-interactive commands, file access requests, programs, networks, and the interactive commands. If a non-interactive command, file access request, program, network, or an interactive command is approved, the command request is then forwarded to the computer operating system. However, at least the '126 patent does not distinguish between data and label names having a predetermined length of character in that an examination means is needed for examining the non-interactive commands and the interactive commands from the user of the computer system software.

There are a number of patents addressing the year 2000 problem in that the teachings are directly related to changing the date of a source code. U.S. Pat. No. 6,237,140 entitled COMPILER-ASSISTED OR INTERPRETER-ASSISTED WINDOWING SOLUTION TO THE YEAR 2000 PROBLEM FOR COMPUTER PROGRAMS teaches a method, apparatus, and article for solving the year 2000 problem involves limited modifications in the data definition portions of the source code and compiler support for processing the modified source code. Fields in the source code that contain a year or date values are identified and, for each such field, the user selects an appropriate technique (for example, expansion, compression or windowing). The user modifies the data definition for each identified field, by adding new attributes to request the selected technique. The user then compiles the program and resolves any ambiguous references to the variables whose definitions were modified. This procedure is applied, module by module, and each processed module is merged into production, after testing, by using a compiler option to disable the use of the new attributes. A compiler option provides for the generation of debugger hooks for each statement that has been affected by modified declarations, which may be used with a suitably equipped debugger or other run-time analysis tool.

There exist, in the prior art, some encryption/decryption, encoder/decoder, systems. However, for these systems, there typically exist a set of two way paths in which the original data or instructions have to be somehow restored. For example, encoding vs. decoding, encrypting vs. decrypting, etc.

Therefore, it is desirous to protect whatever intellectual property contents contained in the source code of computer programs by removing comprehensible text and positional structure, without changing the program logic. In other words, it is desirable a machine (computer) having program products that reads a file containing the input source code to be “cloaked” and writes a file consisting of logically the same source code but with the intellectual property either deleted or replaced with meaningless character strings. This output can then be compiled, linked and run in place of the original program source. More specifically, there is a need for a batch computer program, such as a batch program written in COBOL II, which reads program source code and removes some data or instructions therein such as the self documenting aspect of the code before writing it to an output source code file.

### SUMMARY OF THE INVENTION

A method for transforming source code that is non-specific to computer operating system is provided.

A method for transforming source code in which a “preserve mode” is defined to provide file details and other selected comments that are particularly useful to software producers who wish to allow customers the facility to customize their source code is provided.

Accordingly, the method includes the steps of: reading the input source code; identifying a set of data names and a set of label names having a predetermined word length; comparing the set of data names and the set of label names with a predetermined list; and assigning a cloaked name and placing the same within a predetermined list and to replace the identified data name with the cloaked name. Also, to remove non-essential punctuation, space and new-line characters.

### BRIEF DESCRIPTION OF THE DRAWING

FIG. 1 shows the phase one of a first flowchart depicting the present invention.

FIG. 1A shows the phase two of the flowchart of FIG. 1.

FIG. 2 shows a second flowchart depicting present invention.

FIG. 2A shows a third flowchart depicting present invention.

FIG. 3 shows system suitable for the present invention.

FIG. 4 shows a block diagram of the present invention.

### DETAILED DESCRIPTION OF THE INVENTION

This section includes the descriptions of the present invention including the preferred embodiment of the present invention for the understanding of the same. It is noted that the embodiments are merely describing the invention. The claims section of the present invention defines the boundaries of the property right conferred by law.

The present invention is a system and method applicable in a batch computer program, which may be written in such high level computer program languages as COBOL II. The present invention reads program source code and removes the self documenting aspect of the code before writing the transformed code to an output source code file. Removal of self documentation is accomplished by applying the following changes to the code:

1) Data and label names, more than four characters in length, defined in the source code are replaced with “cloaked” names. These “cloaked” names consist of at least one alphabet or letter such as “O” followed by a random four digit integer, e.g. “O1234”. It is advantageous to have a letter within the cloaked name so that the compiler for compiling purposes doesn't treat the cloaked name as an integer. It is noted that the letter “O” is chosen because it resembles a zero. Other letters may be chosen as well. It is further noted that the position of the letter within the “cloaked” name is immaterial in that it may be position in the first position of the cloaked name, the last position, or anywhere in-between. Names of four characters or less are not replaced by “cloaked” names because they typically cannot express intellectual information.

Furthermore, replacement of original data and label names with “cloaked” names is done in a consistent manner so that multiple occurrences of an original name are replaced with the same “cloaked” name, thereby ensuring that the logical integrity of the program is preserved.

In addition, the random number in “cloaked” names is assigned at run time. This means that if the same program is “cloaked” more than once, the “cloaked” names will be different for each run. This is important in situations where more than one version of the same program has been made available to users to whom it is desirable not to disclose the original source code, for example, outside institutions such as consultants or third parties performing farmed out work. This way, the latest changes cannot be identified by comparing the old and new versions.

2) Comments contained in the source code are removed. This removal includes the removal of in-line comments and continuous line comments as well as single line comments. In the case of COBOL (which is the most self documenting computer programming language) any characters placed in positions 73 through 80 in each source code line are also removed (text in these positions is not interpreted by a compiler and therefore has no impact on the program logic). See infra.

3) Punctuations such as periods, (or full stops according to British usage), semicolons, and commas, are typically removed unless their presence is required by the language syntax or their removal would impact on the program logic. For more specific description, see infra.

4) Redundant spaces and new lines are typically removed unless their presence is required by the language syntax. This process removes the positional structure within the source and places as much source code as possible on each line, thereby removing indentation and a more compact final product.

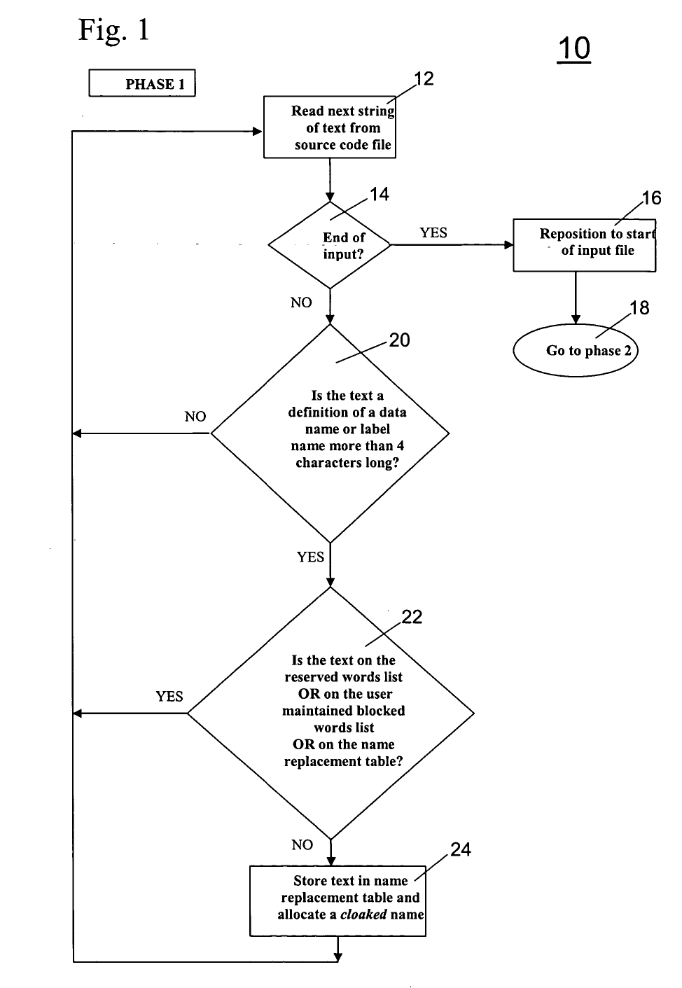

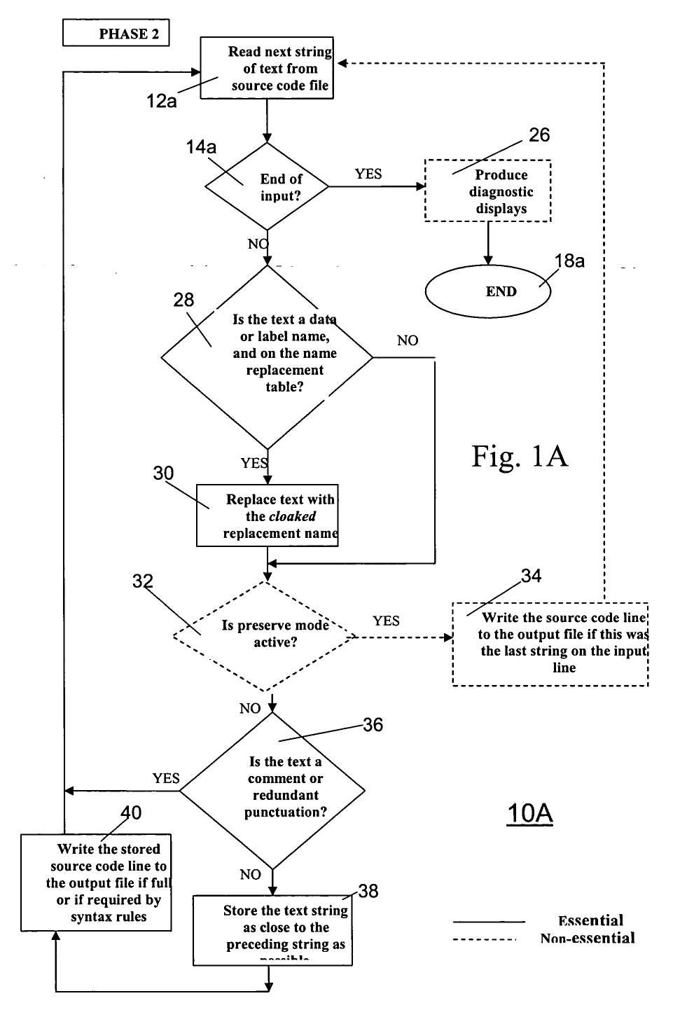

Referring to FIG. 1, a flowchart depicting phase one 10 of the present invention is shown. Source code of some type of high level language, such as COBOL, is in the process of being read. FIG. 1 depicts a method in dealing with a particular word in that source code. After the previous string has been processed, the next string of text from a source code file is being read (step 12). A determination is made thereafter as to whether the input is complete or at its end (step 14). If true, a pointer such as the record pointer is placed at the start of the source code file (step 16), and flowchart 10 proceeds to phase 2 of the present invention 10A (See FIG. 1A infra).

If it is determined that the input is incomplete or not at its end at (step 14), a determination is made as to whether the word or text under processing is the definition of a data name or label name of more than a predetermined length n (step 20). It should be noted that the predetermined length n can be any suitable length such as n=4 shown in the present figure. If the length of text is less than the predetermined length, or if the text is not a definition of a data name or label name, the logic flow directs back to step 12 for a reading of the next string of text.

When the word or text under processing is a definition of a data name or label name of more than a predetermined length n in (step 20), a further determination (step 22) is made as to whether the word or text is identical to a word kept at a specific location by the programmer or user of the method of the present invention. The specific locations may be lookup tables (LUTs), a dictionary file, etc. In the instant flowchart, the specific locations include reserved word list, user maintained blocked words list, and a name replacement table. However, other types of storage means for storing information are contemplated by the present invention as well.

When the word or text is identical to word kept at the specific location, the logic flow directs back to step 12 for a reading of the next string of text. However, if it is not identical, a further step (step 24) is performed before the logic flow directs back to step 12 for a reading of the next string of text. In step 24, a new transformation name or cloaked name is defined and stored in the specific locations such as name replacement table, and a cloaked name is allocated therefore.

As can be seen, phase one 10 can be understood as an initial phase or steps for automatically transforming source code elements such as data name or label name into transformed or cloaked names. It is noted that If an input word is not allocated a “cloaked” name in phase 1 i.e. FIG. 1, it will remain unchanged by phase 2, see FIG. 1A infra, of the “cloaking” process.

Referring to FIG. 1A, a block diagram 10A depicting phase two of the present invention is shown. The next string of text is being read from the source code file (step 12a). Thereafter, a determination is made as to whether an end of input has occurred (step 14a). If the answer is affirmative, diagnostic displays may be produced (step 26). The program then ends (step 18a). If, on the other hand, end of input has not occurred, another determination is made as to whether the text subject to inspection is something already stored in the name replacement table (step 28). If true, replace the subject text with the cloaked replacement name. In other words, if the subject text has already been predefined by a cloaked name, transform the subject text into the already defined cloaked name (step 30). However, if the answer is negative, skip step 30, and proceed to a possible third determination, in which whether a preserve mode is active is determined (step 32). If true, the subject source code line is written to the output file if the same is the last string on the input line (step 34), and the process of phase two 10A starts at step 12a again. If the preserve mode is not active, a fourth determination is made as to whether the subject text is a comment or redundant punctuation (step 36). If true, the process of phase two 10A starts at step 12a again. If the subject text is not a comment or redundant punctuation, the subject text is stored as close to the previous stored text string as possible (step 38). The stored source code line is in turn written to the output file (step 40). It is noted that if the line is full or if syntax rules require that the next text string must be written on a new line.

The following is an example, which shows a simple date validation section written in a COBOL program. It is noted the present invention in not limited by the instant example. Each line in a COBOL program conforms to a reference format, consisting of the following: a six digit line number in columns 1 to 6, an indicator character in column 7, the COBOL code areas in columns 8 to 72, and the comment area in positions 73 to 80. The indicator character in the example may be a space (normal line of code), “*” (comment line), or “-” (continuation line). Data items that are stored in the program's own storage area (e.g., working storage) are named with a prefix of “WS-”.

| 001000 DATE-VALIDATION SECTION. | | This |
|---|---|---|
| 001010****************************************************************** | | section |
| 001020* This section validates a numeric date with a 4 digit year. * | | was |
| 001030****************************************************************** | | written |
| 001040 | | by John |
| 001050 | IF WS-YEAR = 0 | Smith on |

| | | |
|---|---|---|
| 001060 | SET INVALID-YEAR TO TRUE | Dec. |
| 001070 | GO TO DATE-EXIT | 29 2002. |

| | |
|---|---|
| 001080 | END-IF. |
| 001090 | |
| 001100 | IF WS-MONTH = 0 |
| 001110 | OR WS-MONTH > 12 |

| | |
|---|---|
| 001120 | SET INVALID-MONTH TO TRUE |
| 001130 | GO TO DATE-EXIT |

| | |
|---|---|
| 001140 | END-IF. |
| 001150 | |
| 001160 | IF WS-DAY = 0 |

| | |
|---|---|
| 001170 | SET INVALID-DAY TO TRUE |
| 001180 | GO TO DATE-EXIT |

| | |
|---|---|
| 001190 | END-IF. |
| 001200 | |
| 001210 | IF WS-MONTH = 1 OR 3 OR 5 OR 7 OR 8 OR 10 OR 12 |

| | |
|---|---|
| 001220 | IF WS-DAY > 31 |

| | |
|---|---|
| 001230 | SET INVALID-DAY TO TRUE |
| 001240 | GO TO DATE-EXIT |

| | |
|---|---|
| 001250 | END-IF |

| | |
|---|---|
| 001260 | ELSE |

| | |
|---|---|
| 001270 | IF WS-MONTH = 4 OR 6 OR 9 OR 11 |

| | |
|---|---|
| 001280 | IF WS-DAY > 30 |

| | |
|---|---|
| 001290 | SET INVALID-DAY TO TRUE |
| 001300 | GO TO DATE-EXIT |

| | |
|---|---|
| 001310 | END-IF |

| | |
|---|---|
| 001320 | ELSE |

| | | |
|---|---|---|
| 001330 | DIVIDE WS-YEAR BY 4 GIVING WS-QUOTIENT | <<<Leap |

| | | |
|---|---|---|
| 001340 | REMAINDER WS-REMAINDER | <<<year |

| | | |
|---|---|---|
| 001350 | IF WS-REMAINDER = 0 | <<<check |

| | |
|---|---|
| 001360 | IF WS-DAY > 29 |

| | |
|---|---|
| 001370 | SET INVALID-DAY TO TRUE |
| 001380 | GO TO DATE-EXIT |

| | |
|---|---|
| 001390 | END-IF |

| | |
|---|---|
| 001400 | ELSE |

| | |
|---|---|
| 001410 | IF WS-DAY > 28 |

| | |
|---|---|
| 001420 | SET INVALID-DAY TO TRUE |
| 001430 | GO TO DATE-EXIT |

| | |
|---|---|
| 001440 | END-IF |

| | |
|---|---|
| 001450 | END-IF |

| | |
|---|---|
| 001460 | END-IF |

| | |
|---|---|
| 001470 | END-IF. |
| 001480 | |
| 001490 | SET VALID-DATE TO TRUE. |
| 001500 | |

001510 DATE-EXIT.

| | |
|---|---|
| 001520 | EXIT. |

Below is the same section of code after it has been passed through the invention:

001000 O2587 SECTION. IF O0145 = 0 SET O6072 TO TRUE GO TO O1068 END-IF

| | |
|---|---|
| 001010 | IF O7410 = 0 OR O7410 > 12 SET O9731 TO TRUE GO TO O1068 END- |
| 001020- | IF IF O6824 = 0 SET O9510 TO TRUE GO TO O1068 END-IF IF O7410 = |
| 001030 | 1 OR 3 OR 5 OR 7 OR 8 OR 10 OR 12 IF O6824 > 31 SET O9510 TO |
| 001040- | TRUE GO TO O1068 END-IF ELSE IF O7410 = 4 OR 6 OR 9 OR 11 IF |
| 001050- | O6824 > 30 SET O9510 TO TRUE GO TO O1068 END-IF ELSE DIVIDE |
| 001060 | O0145 BY 4 GIVING O3197 REMAINDER O4692 IF O4692 = 0 IF O6824 > |
| 001070 | 29 SET O9510 TO TRUE GO TO O1068 END-IF ELSE IF O6824 > 28 |
| 001080 | SET O9510 TO TRUE GO TO O1068 END-IF END-IF END-IF END-IF SET |
| 001090 | O5085 TO TRUE. |

001100 O1068. EXIT.

As can be seen in this example, a by-product of the “cloaking” process is that the “cloaked” source code has approximately 70% fewer lines than the input code. Furthermore, once a program has been “cloaked”, it is not possible to reverse engineer the source so that meaningful comments, data names or label names are restored. By “not possible”, it is comtemplated that while it could be claimed that, given sufficient time, an experienced programmer could manually reverse engineer “cloaked” code back to something resembling to its original state. However, this would be not unlike claiming that, given sufficient sticky tape, a shreded document could be returned to its original state after being put through a paper shreader. As can be seen, the present invention provides some type of protection of data, but not in a fool proof or almost fool proof incryption device.

In addition, the invention does not check the syntax or logic in the input file. Therefore, if syntax or logic errors exist in the input source code, the same errors will exist in the “cloaked” output source. “Cloaking” a program does not affect the performance of the program when it is run on a computer.

The process of “cloaking” a program source code file produces an additional source code file with the same logical meaning and in the same computer language but with the comprehensible text within it, obscured from the human eye.

The invention contemplates to function in the majority of computer programs or program languages in use today. However, many programs will require additional features such as the ones described below.

The invention contemplates the inclusion of a feature termed “preserve mode” that preserves comments, punctuation and duplicate spaces (positional structure) for selected lines in the input source code. However, the “preserve mode” of the present invention does not preserve the original data/label names because doing so would cause compile errors. This “preserve mode” feature provides the user of the present invention with the ability to pass selected information about a program to others without revealing all lines containing intellectual property. Situations where this may be desirable are when an outside institution is required to run tests of “cloaked” programs and needs access to the file definitions within the program. Alternatively, an outside institution may want to view comments detailing the validation requirements for an input.

The present invention regards any comprehensible text within the source code of a computer program as being the intellectual property of the institution that owns the program source code. It is assumed that the institution that owns the source code, owns the copyright to that source code and that there may be trade secrets written as comprehensible text within the source code. Comprehensible text within “preserve mode” sections is regarded as intellectual property that the owning institution wishes to share with the organization that is being given the “cloaked” source code.

In practice, “Preserve mode” may be activated by the addition of a comment line containing “RCCLOAK:PRESERVE-ON” in the input source code. Similarly, “Preserve mode” may be deactivated by the addition of a comment line containing “RCCLOAK:PRESERVE-OFF” in the input source code. “RCCLOAK” is the COBOL program identifier of the invention, defined at the start of the device source code. “Preserve mode” can be activated and deactivated as many times as necessary.

An important aspect of the present invention is that it can be distributed in identical source code form as that of the source code subject to transformation. By way of an example, if the device is written in COBOL, therefore its source can be “cloaked” like any other COBOL program and the intellectual property constrained therein shall be safe. This allows certain parameters within the invention source code to be adjusted to suit the requirements of individual users of the present invention. These parameters, for example, are referred to as “User Maintained Variables” (UMV) in the invention user guide and these can be found at the start of the device source code where “preserve mode” is active. Some examples of the User Maintained Variables are:

A switch that sets “preserve mode” on by default for the entire input source code or for specific areas of the input source code. If “preserve mode” is set manually by the use of a comment line containing the text “RCCLOAK:PRESERVE-ON” or “RCCLOAK:PRESERVE-OFF”, default preserve settings are lost.

A switch that provides a cross-reference display of original to “cloaked” names when the device is run.

A list of names that are to be blocked from being replaced by “cloaked” names. Under certain circumstances it may be desirable to block specific data or label names from being replaced with “cloaked” names.

The Invention as it Relates to the COBOL Programming Language:

The invention in its current form supports every version of COBOL and COBOL II available for research by the inventor. Specific platforms where the principals of the invention have been proven are IBM OS/390, zSeries, AS400, UNIX, HP3000, CA-Realia, Siemens and Fujitsu.

Specific forms of COBOL input source code that are supported include:

The older COBOL I language as well as COBOL II.

Upper case and lower case characters.

Continuation lines (lines with “-” in column 7).

Programs that have their IDENTIFICATION, ENVIRONMENT OR PROCEDURE DIVISION statements coded in COPY or INCLUDE code.

Data name qualification.

Data name reference modification.

Literals of unlimited length.

Hexadecimal, Boolean, National normumeric and National hexadecimal literals.

The underscore (“_”) character in data or label names.

Data or label names that exceed 30 characters in length (these are not replaced with a “cloaked” name).

In-line comments initiated by the characters “--” or “*>”.

Multiple in-line comments initiated by “{” and terminated by “}”.

Pseudo code (delimited by two equals characters (“==”)).

SQL (Structured Query Language) statements.

Command level CICS (Customer Information Control System) statements.

Specific forms of COBOL input source code that are not supported are:

Source that does not conform to the standard reference format (sequence number in positions 1 through 6; indicator area in position 7; area A in positions 8 through 11; area B in positions 12 through 72).

Programs that do not include the DATA DIVISION statement.

Nested programs.

The present invention will convert any character other than “*” (comment line), “/” (comment line on a new page), “-” (continuation line), or space (normal line), in the indicator area (position 7) to an “*” (comment line). This is done to remove any possibility of debugging or other miscellaneous lines from becoming part of the base program. If “preserve mode” is active, these lines will be written as comment lines.

The present invention does not alter code added to the program at compile time as the result of a COPY or INCLUDE statement. Members of COPY/INCLUDE libraries are outside the input to the device. This fact can give rise to compile errors if data names or label names, defined within the main input source code and therefore replaced with “cloaked” names, are referenced from within COPY or INCLUDE code. This problem is overcome by placing the names affected in the UMV blocked names list, maintained by the device owner.

The present invention does not replace data names or label names that are the subject of a REPLACE statement or if they are written as pseudo code (delimited by two equals characters (“==”)), nor does it remove redundant periods (full stops), duplicate spaces or new lines from REPLACE/pseudo code. However comments and characters beyond column 72 are removed. Code subject to the REPLACE statement and in pseudo code strings are handled in this way because of their close association with COPY and INCLUDE code.

The present invention does not replace data names or label names written as SQL code (initiated by an EXEC SQL statement and terminated by an END-EXEC statement) unless they are coded as host variables (immediately preceded with a colon (:) or dollar sign ($)); or are the subject of a WHENEVER clause. Also, the invention does not remove redundant periods (full stops), duplicate spaces or new lines in SQL code. However comments and characters beyond column 72 are removed. SQL code is handled in this way so that SQL keywords, table, row and column names can use the same names as data or label names defined in the source code without the risk of being replaced.

The present invention does not replace data names or label names written as command level CICS code (initiated by an EXEC CICS statement and terminated by an END-EXEC statement) unless they are coded within parentheses. Also, the invention does not remove redundant periods (full stops), duplicate spaces or new lines in CICS code. However comments and characters beyond column 72 are removed. CICS code is handled in this way so that CICS function and option names can use the same names as data or label names defined in the source code without the risk of being replaced.

The present invention, also known as the Redvers Cloaking Device solves these problems by generating program source code that has no comprehensible meaning (intellectual property), while retaining its source code status. Therefore, the “cloaked” source code can be compiled onto any platform that supports the source code language, “preserve mode” can retain selected lines of the original source code and compiler directing statements like COPY and INCLUDE can invoke library source code members.

The Operation of the Invention:

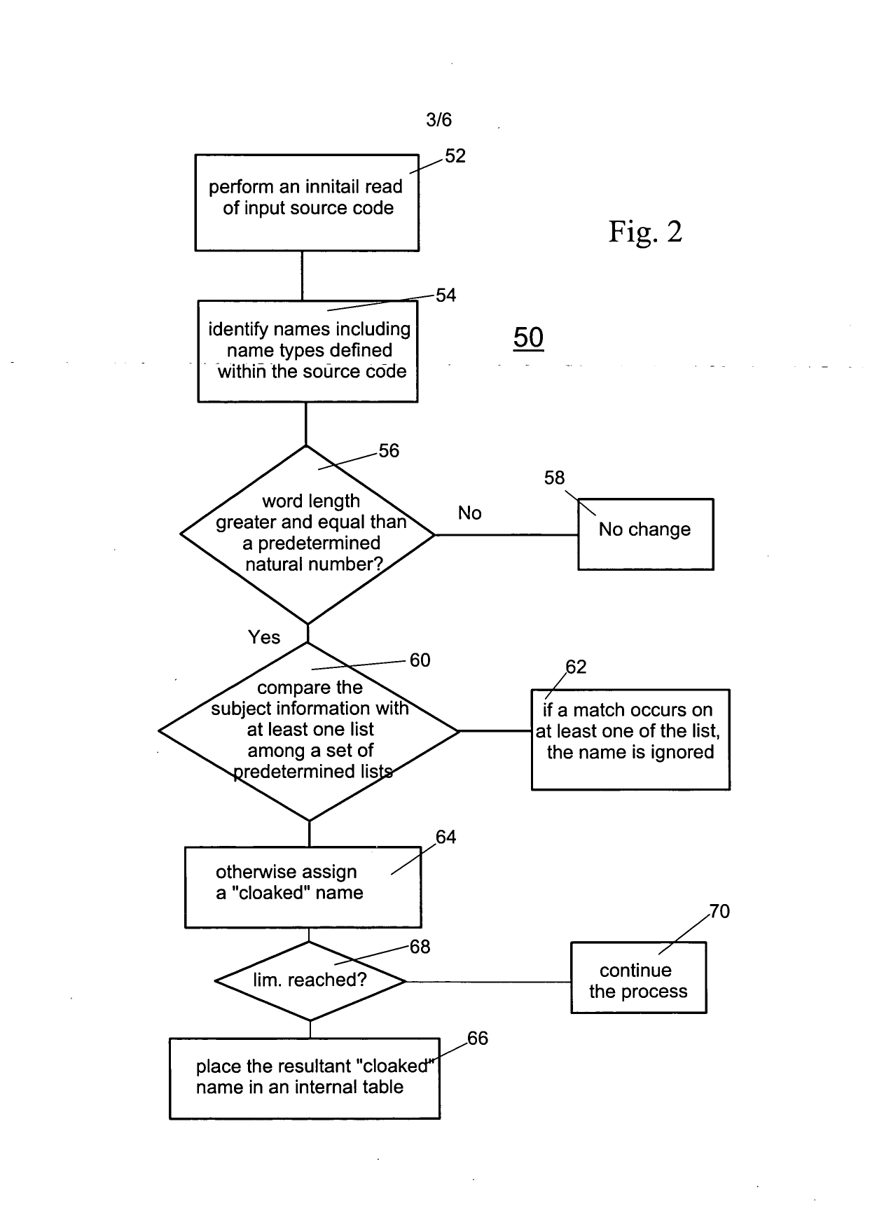

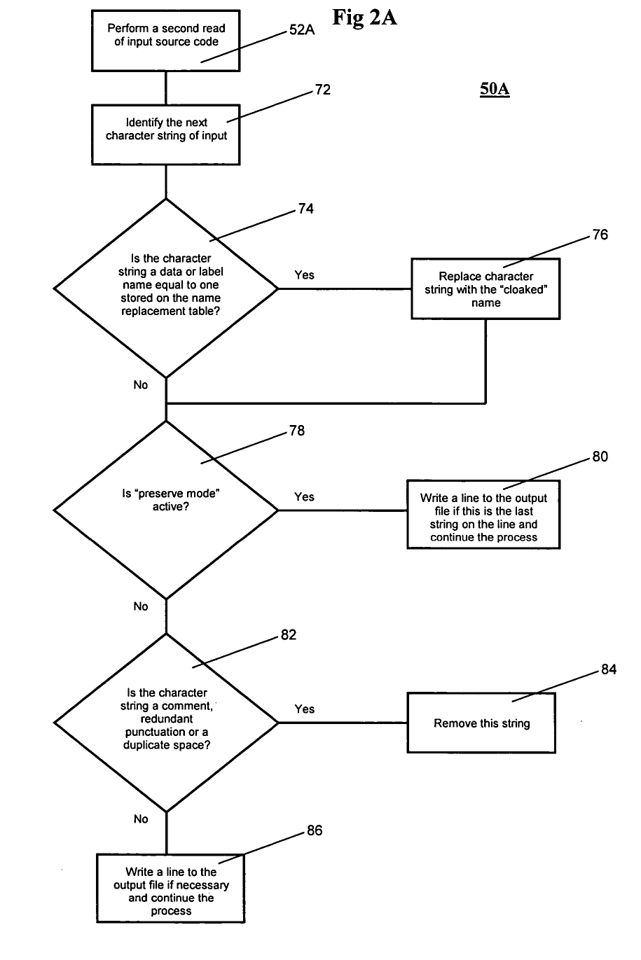

Referring to FIG. 2, a flowchart 50 of the present invention is provided. A source code is provided. The present invention starts by performing an initial read of the input source code (step 52), and identifying all data names and label names defined in the program (step 54) that are longer than a predetermined length of character represent by a natural number n, e.g., 4 characters. A determination regarding the length of the subject word is made (step 56). If the length of character is less than n, no change occurs (step 58). Otherwise, the method of the present invention further compares each of these input names with a set of predetermined lists such as an internal list of reserved names as well as the U MV blocked names list maintained by the programmer or user of the present invention (step 60). If a match occurs on either list or if the name has been processed previously, the name is ignored (step 62). Names not ignored, are assigned a “cloaked” name (step 64) and placed in the internal name replacement table (step 66). The size of the internal name table has a limited size, for example, up to 6,000 entries. A determination is made before the placing of the resultant cloaked name in the internal table (step 68) If this limit is reached the device continues processing but no further names are added to the table (step 70).

When the initial read is complete, the invention logic restarts from the first string on the first line of the input source code and begins storing the various character strings that make up the program. If a character string matches a name in the internal name table, it is replaced with its “cloaked” counterpart. If comment character strings are encountered, they are ignored. If punctuation characters are encountered, they are ignored if the language syntax doesn't require them to be present and if their removal wouldn't affect the program logic. If duplicate spaces are encountered and they don't make up part of a literal string, they are replaced with a single space.

When sufficient character strings are stored to fill a complete line of output or if the language syntax requires a new line, the stored line is written to the output file. If the last character string in a stored line can't fit onto an output line in its entirety, the excess characters remain in storage to be placed at the start of the next line which will be a continuation line.

It is noted that the whole input source code is read again once phase one has been completed. The first phase (or phase one) is used to identify all the names that are to be cloaked, in which nothing is written as output. The second phase (or phase two) performs the actual substitution and creation of the output source code. It has to be done this way because names at the start of the source code may not be definitions, just references to names that are defined later on. However the invention cannot be certain that they WILL be defined later

If “preserve mode” is activated during the second read of the input source code, character strings within the line are checked against the internal name table and replaced with “cloaked” names if a match exists. The entire line is then written to the output source code file without any other changes.

When the second read of the input source code is complete, the invention displays diagnostic information on when the run took place, how many data and label names were identified for replacement, the number of replacements that have taken place, how many lines were in the input file and how many lines were written by the device.

Due to the fact that the invention doesn't attempt to validate the input file, there are only two conditions under which the device can fail. The first is that the free trial period has expired (the device may be offered to prospective clients on a free trial basis for a specified number of days). The second is if the device discovers that its own source code has been tampered with (except for User Maintained Variables).

Referring to FIG. 2a a flowchart 50A depicting the phase two of the present invention is shown. A second read of input source code is performed (step 52A). The next character input string is identified (step 72) by such entities as the controller. A first determination is performed to determine whether the identified character string is data or label name already stored in the look up table such as the name replacement table (step 74). If the identified character string includes elements contained within the look up table, the elements are replaced with the new cloaked name (step 76). A second determination is performed as whether the preserve mode is active (step 78). If the preserve mode is active, perform step 80 in which a line is written to the output file if this is the last string on the line. The process continues (step 80). Otherwise, a third determination is performed as whether the character string is a comment, redundant punctuation, or a duplicate space (step 82). If the answer is in the affirmative, the character string is removed from further processing (84). Otherwise, write a line to the output file if necessary such as the character string progresses to the end of a line. The process continues (step 86).

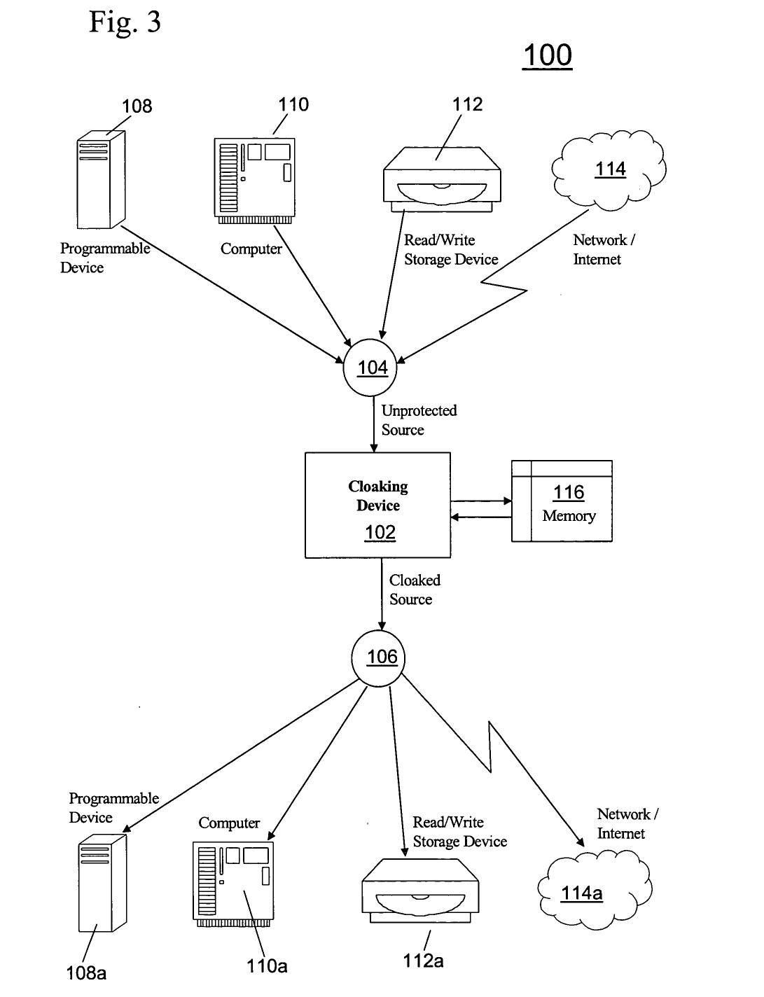

Referring to FIG. 3, a system 100 suitable for the present invention is depicted. A cloaking device 102 of the present invention is interposed between an input source code cluster 104 and an output source cluster 106. Input source code cluster 104 processes unprotected source code coming from devices originating from computer related firms big and small. But the unprotected source code may also come from small firms such as a firm with a single computer program product in source code form as its main product. Cluster 104 receives unprotected source code from a number of devices. These devices include a programmable device 108 such as a computer programmer's work station; a computer 110 such as a mainframe computer of a big firm; a read/write storage device 112 such as a back up library of a storage area network (SAN), a set of hard disks such as a RAID system, a writable optic device, or a simple floppy disk; or alternatively the unprotected source code may come from a network 114 such as a local area network (LAN), a metropolitan network (MAN), or a wide area network (WAN) including the Internet.

The unprotected source code is clustered in input source code cluster 104 and inputted into cloaking device 102 of the present invention. In device 104, the unprotected source code is subjected to processing of the present invention. The resultant source code, or the cloaked source code is outputted into output source cluster 106, and in turn terminates at designated devices. The designated devices include a programmable device 108a such as a computer programmer's work station; a computer 110a such as a mainframe computer of a big firm; a read/write storage device 112a such as a back up library of a storage area network (SAN), a set of hard disks such as a RAID system, a writable optic device, or a simple floppy disk; or alternatively the unprotected source code may come from a network 114a such as a local area network (LAN), a metropolitan network (MAN), or a wide area network (WAN) including the Internet.

It is noted that programmable device 108a; computer 110a; read/write storage device 112a; or network 114a may be identical as programmable device 108; computer 110; read/write storage device 112; or network 114.

Cloaking device 102 interacts with a memory 116 which includes look up tables for the present invention. A controller (not shown) controls the operation of the present invention. Alternatively, the present invention may use contollers residing within device 108, computer 110, device 112, or network 114.

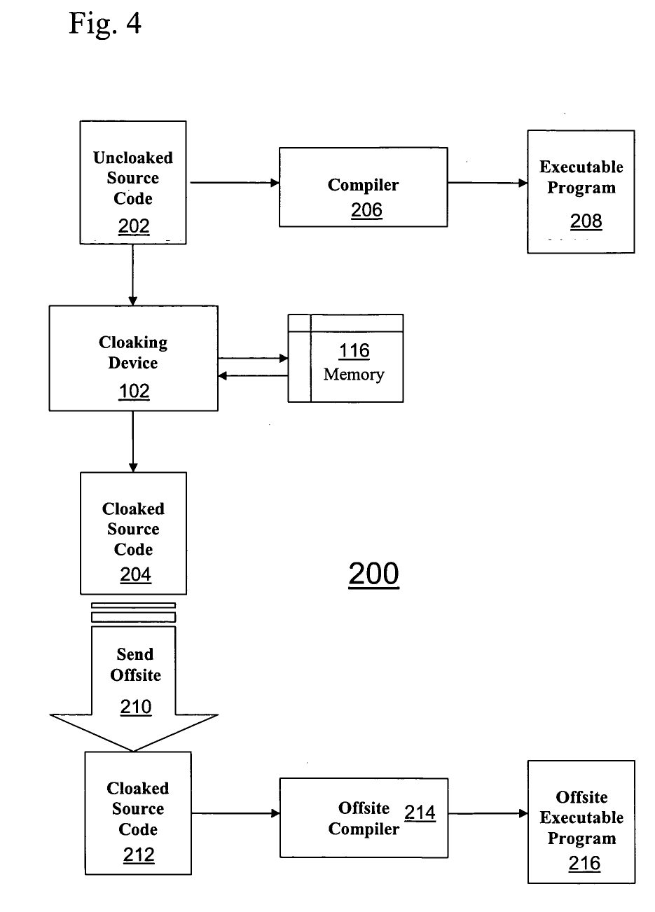

Referring to FIG. 4, a block diagram 200 of the present invention is depicted. Clocking device 102 is interposed between uncloaked source code 202, and the cloaked source code 204. In other words, uncloaked source code 202 operates as the input and cloaked source code 204 as the output of Clocking device 102. The uncloaked source code 202, if not processed by the cloaking device 102 will typically be processed using known compiler 206 and then transformed into an executable program 208 for execution.

The cloaked source code 204 may be sent offsite for use (step 210), or alternatively may be used inhouse (not shown). The sent cloaked source code 212 in turn are processed by compiler 214, and executable program 216

It is noted that the 2 compilers typically are not identical. The compiler 214 is an off-site compiler used by entities such as a customer, competitor, backup service bureau, or may be even owned by the same company. The most important thing is that compiler 214 could be running on the computer of a different manufacturer, design, age, type or operating system. Although compiler 214 and compiler 206 may be identical. The above applies to the executable program 216 as well.

Cloaking device 102 interacts with a memory 116 which includes look up tables for the present invention.

It is noted that the present invention may be used by a user who wish to use to same for archiving, backup, or even send the same to an outside firm such as financial institutions, government departments, utility companies, or large manufacturing firms.

### Alternatives

The format of the “cloaked” names does not need to be “0” followed by four numeric characters. It could be changed to use any alphanumeric string of any length that can produce a minimum of 6,000 unique combinations (if the number of entries in the internal name table is to remain at 6,000).

The size of the internal name table does not have to be 6,000 entries. This number was judged to be sufficient for 99.9% of programs.

The invention would work better if it could be combined with a compiler. This would allow the device to “cloak” code introduced at compile time from source code libraries as well as the main source code input, thereby removing the possibility of uncloaked library code referencing “cloaked” data and label names.

“Preserve mode” is not an essential part of the invention. It is to provide ease of use particularly for customers who may want to use the device to sell software tools written in source code.

None of the four methods of removal of intellectual property (1: replacement of names/labels, 2: removal of comments, 3: removal of punctuation and 4: removal of duplicate spaces and new lines) are essential in their own right. It is the combined effect of the four processes that makes the “cloaking” process difficult to reverse engineer.

The invention can be used to protect intellectual property in specific programs when the whole system is sent to an outside institution for further development (outsourcing) or for offsite backup purposes, particularly if the offsite is on a different computer platform (type of computer). It may also be used within the company that owns the intellectual property, in order to shield such details from its own employees or contract staff. It may also be used when a program or system is to be archived or if it is to be deliberately frozen in its current state so that no further changes can be applied to it.

The invention makes it possible to market computer products in source code form without releasing the intellectual property contained within the code. This allows sellers to target customers on all platforms that support a given language, rather than marketing objects (code after it has been compiled) which will only run on specific platforms.

The fact that the “cloaked” code requires far fewer lines than the original code, means that it could be used to save on the amount of storage necessary to store the source code for a system. This aspect makes it suitable for archiving programs and systems.

The invention could be used maliciously so that an organization does not realize that the intellectual property has been removed from its source code library. This is not the intention of the inventor.

### Situations Wherein the Present Invention will Not Work as Desired

The invention in its current form will not work if the input COBOL source code does not conform to the standard COBOL reference format (sequence number in positions 1 through 6; indicator area in position 7; area A in positions 8 through 11; area B in positions 12 through 72, ignored text in positions 73 through 80).

The invention in its current form will not work if the input COBOL source code does not include the DATA DIVISION statement at the appropriate location within the input source.

The invention in its current form will not work if the input COBOL source code includes nested programs due to the fact that multiple DATA DIVISION statements will be present.

The invention in its current form will only terminate abnormally if a predetermined free trial end date is found to have expired or if its own source code is tampered with. It will not terminate abnormally due to invalid input data but will pass the invalid data to the output file.

One embodiment of the invention is implemented as a program product for use with a computer system such as, for example, the schematics shown in FIG. 2, FIG. 3, and described below. The program(s) of the program product defines functions of the embodiments (including the methods described below with reference to FIGS. 1, 1A and 4 and can be contained on a variety of signal-bearing media. Illustrative signal-bearing media include, but are not limited to: (i) information permanently stored on in-circuit programmable devices like PROM, EPPOM, etc; (ii) information permanently stored on non-writable storage media (e.g., read-only memory devices within a computer such as CD-ROM disks readable by a CD-ROM drive); (iii) alterable information stored on writable storage media (e.g., floppy disks within a diskette drive or hard-disk drive); (iv) information conveyed to a computer by a communications medium, such as through a computer or telephone network, including wireless communications, or a vehicle controller of an automobile. Some embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is noted that the present invention teaches an apparatus and method for transforming an input source code in a unidirectional sense in that once the original source code is cloaked; the original source code is not restored in any sense of the word. In other words, the source code is not encrypted and then decrypted, or encoded/decoded, etc.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A method for transforming an input source code, comprising the steps of:
performing a first reading of the input source code;
identifying a set of data names and a set of label names having a predetermined word length;
comparing the set of data names and the set of label names with a predetermined list; and
assigning a cloaked name, and placing the same within a predetermined list.

2. The method of claim 1 further comprising performing a second reading of the input source code.

3. The method of claim 1 further comprising identifying a set of input character strings sequentially.

4. The method of claim 1 further comprising replacing the character strings with the cloaked name.

5. The method of claim 1 further comprising writing a line to the output file if a preserve mode is active.

6. The method of claim 1 further comprising removing a string from further processing.

7. The method of claim 6, wherein the string removed comprises comment, redundant punctuation, or a duplicate space.

8. The method of claim 1, wherein the predetermined list comprises a look up table (LUT).

9. The method of claim 1 further comprising writing the cloaked data to an output source file

10. The method of claim 1, wherein the predetermined list comprises reserved name, and blocked names.

11. The method of claim 1 further comprising

12. The method of claim 1, wherein the transformation is unidirectional thereby the transformed subject matter is not transformed back to the untransformed state.

13. The method of claim 1, wherein the word length is greater and equal than four bytes.

14. An apparatus comprising:
reading means for reading an input source code;
identifying means for identifying a set of data names and a set of label names having a predetermined word length;
comparing means for comparing the set of data names and the set of label names with a predetermined list; and
assigning means for assigning a cloaked name, and placing the same within a predetermined list.

15. The method of claim 1 further comprising replacing means for replacing the character strings with the cloaked name.

16. The method of claim 1 further comprising writing means for writing a line to the output file if a preserve mode is active.

17. The method of claim further comprising removing means for removing a string from further processing.
